(19) United States
(12) Patent Application Publication
(10) Pub. No.: US 2013/0064615 A1
(43) Pub. Date: Mar. 14, 2013

(54) PORTABLE DEVICE FOR PRODUCING STANDARDIZED ASSAY AREAS ON ORGANIC COATINGS

(71) Applicants: Li Lin, Wallingford, PA (US); Shi Hua Zhang, Wilmington, DE (US)

(72) Inventors: Li Lin, Wallingford, PA (US); Shi Hua Zhang, Wilmington, DE (US)

(73) Assignee: E I DuPont De Nemours and Company, Wilmington, DE (US)

(21) Appl. No.: 13/699,006

(22) PCT Filed: Jun. 29, 2010
(86) PCT No.: PCT/US10/40318

§ 371 Date: Nov. 20, 2012

Related U.S. Application Data
(60) Provisional application No. 61/349,536, filed on May 28, 2010.

(51) Int. Cl. B23B 39/04

(52) U.S. Cl. 408/8

(57) ABSTRACT

The present disclosure is directed to a portable device for producing standardized assay areas on conductive substrates coated with organic coating layers. The present disclosure is directed to a process for producing standardized assay areas using the portable device. The portable device and the process can be used to produce assay areas for corrosion evaluation tests at an accelerated rate. The portable device and the process are particularly useful for producing standardized assay areas on large or immobile structures or objects.

### FIELD OF DISCLOSURE

The present disclosure is directed to a portable device for producing standardized assay areas on conductive substrates coated with organic coating layers. The present disclosure is directed to a process for producing standardized assay areas. The portable device and the process can be used to produce assay areas for corrosion evaluation tests at an accelerated rate.

### BACKGROUND OF DISCLOSURE

Currently, there is no short-term test method, i.e., less than 2 days, for evaluating the long-term corrosion protection performance afforded by a protective coating. Current standard test methods rely primarily on environmental exposure for many days or even many months, and then followed by visual and mechanical testing. Such tests can require long assay time and the results are often not reproducible and difficult to compare.

One of the current standard test methods comprises the steps to scribe coating layers coated on a substrate in either an “X” or “#” pattern, also known as cross-hatch pattern. The scribed areas (or lines) would expose the metal substrate under the coating layers to the environment so that corrosion can occur. Since the scribing is usually made manually using a knife or other sharp objects, inconsistent scribe areas can occur and can affect consistency of test results.

Another method is laser ablation. The laser ablation of coating layers over a substrate can produce desired sizes and patterns of defects in coating layers, such as one or more spots or one or more lines. A thin line cutting through the coating layers and exposing underling substrate with a micrometer width can be generated consistency. However, the laser ablation may not penetrate some coatings containing special pigments. In addition, the heat generated can change the property of the coating-substrate interface and affect accuracy of the testing results.

### STATEMENT OF DISCLOSURE

This disclosure is directed to a portable rotary tool comprising:
a) a rotatable member (10) adapted to receive a cutting element, the rotatable member being electrically conductive;
b) a motive source (11) attached to said rotatable member for rotating the rotatable member, said motive source being electrically insulated from said rotatable member;
c) a motive controller (12) for controlling power supply and rotation directions of the motive source;
d) a sensing device (13) functionally coupled to said motive controller (12), said sensing device being electrically connected to the rotatable member (10) and an electrical reference terminal (14);
e) a main frame (15) attached to said motive source and a frame base (16) attached to said main frame; and
f) an advancing controller assembly for advancing said rotatable member along a rotational axis of said rotatable member.

This disclosure is also directed to a portable rotary tool kit comprising:
a) a rotatable member (10) adapted to receive a cutting element, the rotatable member being electrically conductive;
b) a motive source (11) attachable to said rotatable member for rotating said rotatable member;
c) an insulator coupling for coupling said motive source and said rotatable member so that when assembled, said motive source being electrically insulated from said rotatable member;
d) a motive controller (12) for controlling power supply and rotation directions of the motive source;
e) a sensing device (13) for coupling to said motive controller (12), said sensing device being electrically connectable to the rotatable member (10) and an electrical reference terminal (14); and
f) an advancing controller assembly for advancing said rotatable member along a rotational axis of said rotatable member.

This disclosure is also directed to a process for producing one or more assay areas on a coated article, said coated article comprises a conductive substrate and one or more non-conductive coating layers coated over said conductive substrate, said process comprising the steps of:
(A) providing a portable rotary tool comprising:
   a) a rotatable member (10) adapted to receive a cutting element, the rotatable member being electrically conductive;
   b) a motive source (11) for rotating the rotatable member, said motive source and said rotatable member being electrically insulated from each other;
   c) a motive controller (12) for controlling power supply and rotation directions of the motive source;
   d) a sensing device (13) functionally coupled to said motive controller (12), said sensing device being electrically connected to the rotatable member (10) and an electrical reference terminal (14);
   e) a main frame (15) attached to said motive source and a frame base (16) attached to said main frame; and
   f) an advancing controller assembly for advancing said rotatable member along a rotational axis of said rotatable member;
(B) attaching the cutting element to said rotatable member (10), said cutting element being conductive and in conductive contact with said rotatable member;
(C) positioning said portable rotary tool over the coated article at a first position;
(D) connecting said electrical reference terminal (14) to said conductive substrate so that said electrical reference terminal and said conductive substrate are in conductive contact;
(E) providing a forward signal to said motive controller (12) to power said motive source causing forward rotation of said rotatable member and said attached cutting element at a predetermined forward rotation rate;
(F) advancing said cutting element with said advancing controller assembly to cut through said one or more non-conductive coating layers at said first position; and
(G) interrupting the power supply to the motive source after a predetermined time delay or a predetermined number of rotations when said sensing device detects a flow of electric current through the rotatable member and the electrical reference terminal.

### BRIEF DESCRIPTION OF DRAWING

FIG. 1 shows a schematic presentation of an example of a configuration of an assembled portable rotary tool and some of the components and parts. (A) A side view of an example of the rotary tool. (B) A detailed view of an example of the rotary tool. Not all parts are shown. Drawings may not be to scale. (C) An example of a coplanar configuration.

FIG. 2 shows a schematic presentation of an example of an assembled portable rotary tool and a coated article. (A) The rotary tool at a position before cutting, (B) The rotary tool at a position at a position adjusted for cutting. (C) A schematic view of an example of sensing device connections.

FIG. 3 shows schematic presentations of side cross-sectional views of assay areas. (A) An assay area exposes the conductive substrate. (B) An assay area with no exposure of the conductive substrate. (C) (F) Assay areas with various assay surface areas and depths.

FIG. 4 shows schematic presentations of side cross-sectional views of assay areas before reverse rotation (A) and (B) and after reverse rotation (C). (D) A schematic presentation of side cross-sectional view of an assay area with a cut into the conductive substrate.

FIG. 5 shows schematic presentations of assay areas patterns. (A) A top down view of an example of an assay area pattern. (B) A side cross-sectional perspective view of the assay area pattern.

### DETAILED DESCRIPTION

The features and advantages of the present disclosure will be more readily understood, by those of ordinary skill in the art, from reading the following detailed description. It is to be appreciated that certain features of the DISCLOSURE, which are, for clarity, described above and below in the context of separate embodiments, may also be provided in combination in a single embodiment. Conversely, various features of the disclosure that are, for brevity, described in the context of a single embodiment, may also be provided separately or in any sub-combination. In addition, references in the singular may also include the plural (for example, “a” and “an” may refer to one, or one or more) unless the context specifically states otherwise.

The use of numerical values in the various ranges specified in this application, unless expressly indicated otherwise, are stated as approximations as though the minimum and maximum values within the stated ranges were both proceeded by the word “about.” In this manner, slight variations above and below the stated ranges can be used to achieve substantially the same results as values within the ranges. Also, the disclosure of these ranges is intended as a continuous range including every value between the minimum and maximum values.

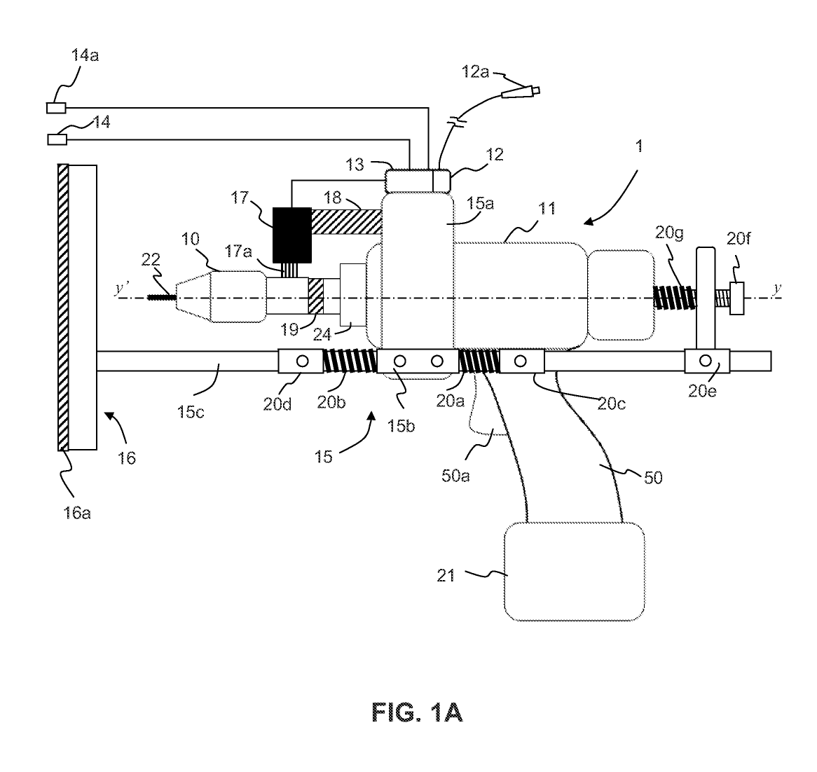

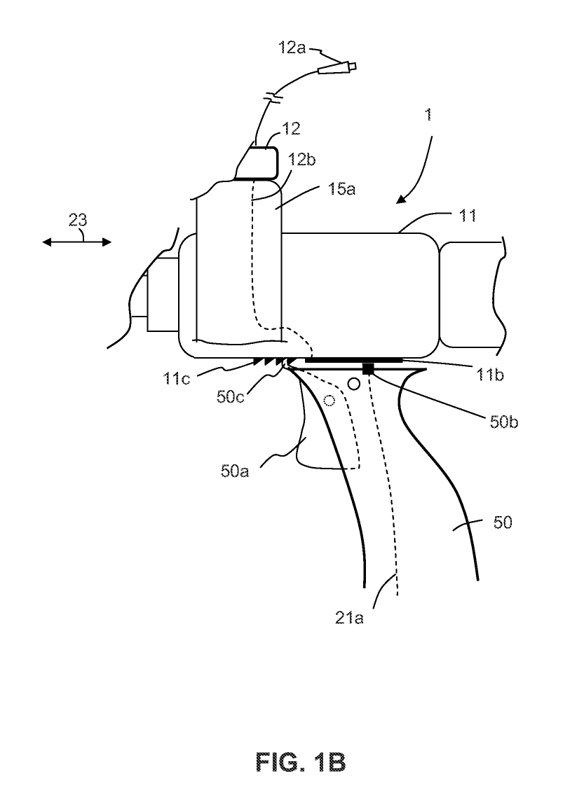

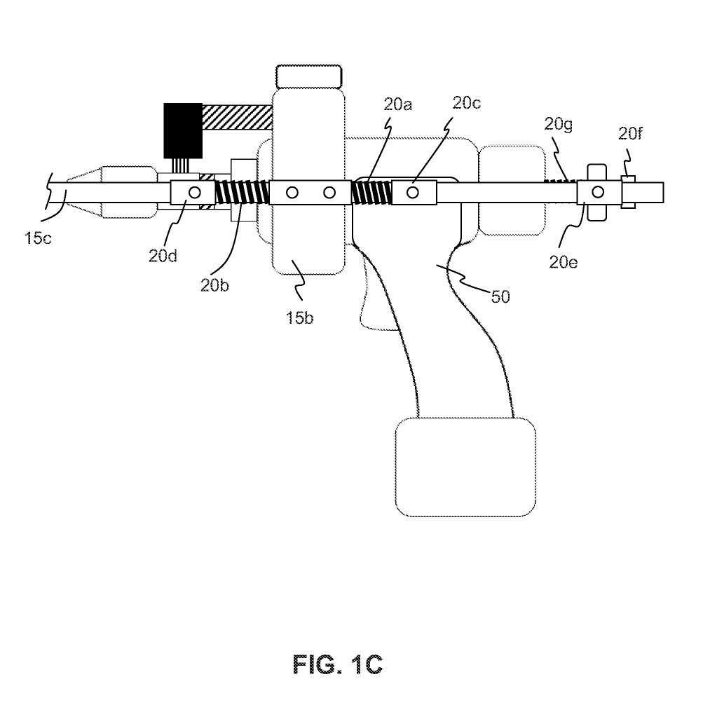

This disclosure is directed to a portable rotary tool. One example of the portable rotary tool is shown in FIG. 1. The portable rotary tool can comprising:

a) a rotatable member (10) adapted to receive a cutting element, the rotatable member being electrically conductive;

b) a motive source (11) attached to said rotatable member for rotating the rotatable member, said motive source being electrically insulated from said rotatable member;

c) a motive controller (12) for controlling power supply and rotation directions of the motive source;

d) a sensing device (13) functionally coupled to said motive controller (12), said sensing device being electrically connected to the rotatable member (10) and an electrical reference terminal (14);

e) a main frame (15) attached to said motive source and a frame base (16) attached to said main frame; and

f) an advancing controller assembly for advancing said rotatable member along a rotational axis of said rotatable member.

The rotatable member (10) can comprise a chuck that can receive a cutting element such as a drill bit. The rotatable member, the chuck and the cutting element are in electrical contact.

The motive source (11) can be a direct current (DC) electric motor.

The rotatable member (10) and the motive source (11) can be coupled via a shaft insulating coupling (19) and a shaft coupling (24) that can transmit rotation power from the motive source to the rotatable member. A non-conductive nylon coupling can be suitable as the shaft insulating coupling (19).

The sensing device can apply a low voltage, such as a voltage in a range of from 0.01 V to 36 V, to the rotatable member (10) and the electrical reference terminal (14). Other range of voltages can also be suitable. A low voltage can be preferred since it can produce less spark or heat. A voltage in a range of from 0.01 V to 24 V can be used in one example, a voltage in a range of from 0.01 V to 12 V can be used in another example, a voltage in a range of from 0.01 V to 6 V can be used in yet another example, a voltage in a range of from 0.01 V to 3 V can be used in a further example. The voltage can be the same as the voltage of the battery pack (21) or different. The sensing device can detect a flow of electric current through the rotatable member (10) and the electrical reference terminal (14). When the rotatable member (10) and the electrical reference terminal (14) are not in electric contact, electric current will not flow therethrough. When the rotatable member becomes in direct electric contact with the electrical reference terminal, such as both are in direct contact with a conductive substrate, electric current can flow therethrough. In one example, the electrical reference terminal (14) can be affixed to the frame base (16) so that it can penetrate through the coating layers reaching the conductive substrate when the frame base is pushed against the coated article. The electrical reference terminal (14) can also be directly affixed to the metal substrate of the article, such as the metal part of a bridge.

The sensing device can be connected to the rotatable member via a conductive coupler (17) that comprises a constant contact means (17a). The constant contact means can maintain electric contact even when the rotatable member is rotating. In one example, the conductive coupler can be a copper coupler and the constant contact means can be an electric brush. The conductive coupler can be attached to the main frame (15) via a non conductive adapter (18) so the rotatable member and the main frame can be insulated. An adaptor made from non-conductive nylon or other non-conductive materials can be suitable.

The term “conductive” means electric conductive. The term “insulated” or “insulate” means electric insulated. The term “conductive contact”, “electric contact”, or “electrical contact” refers to electric contact between two or more objects that are electrical conductive that a flow of electric current can flow therethrough.

The motive controller (12) can be configured to control power supply from a battery pack (21) to the motive source (11). The battery pack (21) can supply electric power at a voltage in a range of from 0.5 V to 36 V. The motive controller (12) can be configured to interrupt the power supply to the motive source after a predetermined time delay or a predetermined number of rotations when the sensing device detects a flow of electric current through the rotatable member and the electrical reference terminal. The predetermined time delay can be in a range of from 0 second to 60 seconds. In one example, the predetermined time delay can be in a range of from 0.01 second to 20 seconds. In another example, the predetermined time delay can be in a range of from 0.01 second to 10 seconds. In yet another example, the predetermined time delay can be in a range of from 0.01 second to 5 seconds. In yet another example, the predetermined time delay can be in a range of from 0.01 seconds to 2 seconds. In yet another example, the predetermined time delay can be in a range of from 0.1 second to 2 seconds. The predetermined number of rotations can be in a range of from 1 to 50 rotations.

The motive controller can be further configured to subsequently provide power supply to the motive source and to cause the motive source to rotate at a reverse rotation direction for a predetermined reverse time period or for a predetermined number of reverse rotations. The predetermined reverse time period can be in a range of from 0.01 second to 50 seconds. The predetermined number of reverse rotations can be in a range of from 1 to 50 rotations.

The motive controller can be configured to cause the motive source to rotate the rotatable member at a forward rotation rate in a range of from 1 to 1000 rpm. The forward rotation rate can be in a range of from 1 to 500 rpm in one example, 5 to 100 rpm in another example, 5 to 50 rpm in yet another example, 5 to 20 rpm in a further example, 5 to 10 rpm in a yet further example.

The motive controller can be configured to cause the motive source to rotate the rotatable member at a reverse rotation rate in a range of from 1 to 1000 rpm. The reverse rotation rate can be in a range of from 1 to 500 rpm in one example, 5 to 100 rpm in another example, 5 to 50 rpm in yet another example, 5 to 20 rpm in a further example, 5 to 10 rpm in a yet further example.

The motive controller can comprise a start device (12a). The start device can be a push button. The start device can be part of the motive controller. The push button can also be extended with a flexible connection so any movements of the push button are not affecting the position of the motive source.

A battery pack (21) can be used for supplying power to the motive source controlled by the motive controller. The battery pack can be affixed to a handle (50).

The main frame (15) can comprise a frame adaptor (15a) for attaching the motive source, one or more sliding adaptors (15b) attached to the frame adaptor (15a), and one or more frame bars (15c), wherein the sliding adaptor (15b) can slide along the frame bar (15c). Two sliding adaptors (15b) and two frame bars (15c) can be suitable for a rotary tool. The handle (50) can be attached to the main frame at a predetermined position. The handle (50) can comprise a set of handle wiring (21a) connectable to the battery pack (21) and handle electric contacts (50b) that can provide electric connect to one or more motive source electric connectors (11b) of the motive source. The motive source electric connectors (11b) can be connected to a set of power wiring (12b) to provide electric power from the battery pack to the motive source via the motive controller (FIG. 1B). A set of sliding electric contacts can be suitable for maintain electric contact while the tool body is advancing during cutting. A socket shoe type mount can be suitable for attaching the handle to the main frame and for providing electric contact. The handle can be fixed into position by one or more fixers. Wired electric connections can also be suitable. The handle (50) can further comprise a lock switch (50a) that can be connected to a lock hatch (50c). The lock hatch (50c) can engage with a hatch engagement (11c) to lock the motive source in place. The hatch engagement (11c) can have one or more positions to engage the lock hatch and can be affixed to any one of the motive source (11), the sliding adaptor (15b), the frame adaptor (15a), or a combination thereof. In one example, the hatch engagement can be affixed to the motive source (FIG. 1B). In another example, the lock switch (50a) can have a spring device to keep the lock hatch engaged with the hatch engagement unless the lock switch is depressed. In yet another example, the lock switch (50a) can have an engaged position that keeps the lock hatch engaged with the hatch engagement and an open position that disengages the lock hatch and the hatch engagement, wherein the two positions can be switched.

The advancing controller assembly can comprise one or more advancing springs (20g) for advancing said motive source, one or more advancing fixers (20e) for attachment between said advancing springs and the main frame, and one or more advancing adjusters (20f) for adjusting said advancing springs, wherein said advancing springs (20g) are positioned in alignment with said rotational axis. The advancing controller assembly can be attached to the main frame (15) by affixing the advancing fixers (20e) to the frame bar (15c). The advancing controller assembly can be affixed to the frame bar at an end distal to the frame base (16). The advancing springs (20g) can be positioned at one end of the motive source distal to the rotatable member and can be aligned with the rotational axis, shown in FIG. 1A as y-y′.

The advancing controller assembly can further comprise one or more second advancing springs (20a), one or more second advancing fixers (20c), one or more balance springs (20b), and one or more balance fixers (20d). The advancing springs (20a), the second advancing fixers (20c), the balance springs (20b), and the balance fixers (20d) can slide along the frame bar (15c). The second advancing fixers (20c) and the balance fixers (20d) can also be fixed into positions by screws or other fixing means such as hatches, clamps, clips, etc. The advancing controller assembly can be assembled so that each of the sliding adaptors (15b) can be positioned between one of the second advancing springs (20a) and one of the balance springs (20b). The second advancing fixers (20c) can control the positions of the second advancing springs (20a), and the balance fixers (20d) can control the positions of the balance springs (20b). The advancing springs (20g) can provide advancing forces in alignment with the rotational axis. The advancing springs can be anchored to the motive source and to the advancing fixers (20e) so the advancing springs can be pressed and pulled. In one example, two springs can be used as the advancing springs. One can be anchored for providing force when being pulled and one can be used for providing force when being compressed. One example of the advancing controller assembly can be shown in FIG. 1A. To have smooth advancing movement during cutting operation, the frame bars, the rotational axis y-y′, the balancing springs, and the advancing springs can be arranged in a coplanar configuration. One example of such coplanar configuration can be shown in FIG. 1C.

The advancing controller assembly can provide an advancing distance in a range of from 0.001 millimeter (mm) to 10 mm. The advancing distance can be 0.001 millimeter (mm) to 10 mm in one example, 0.001 mm to 5 mm in another example, in a range of from 0.001 mm to 2 mm in another example, in a range of from 0.001 mm to 1 mm in yet another example, in a range of from 0.001 mm to 0.5 mm in yet another example, in a range of from 0.001 mm to 0.1 mm in a further example.

The advancing controller assembly can be used to adjust drilling depth and to move the tool body (1) in the directions (23) parallel to the rotational axis y-y′ of the rotatable member. The tool body refers to an assembly of the motive source, the rotatable member and any other necessary accessories, such as cutting elements (22), the conductive coupler (17), the constant contact means (17a), the non-conductive adapter (18), and adaptor (19). The tool body can also include the frame adaptors (15a), the sliding adaptors (15b), and the motive controller (12).

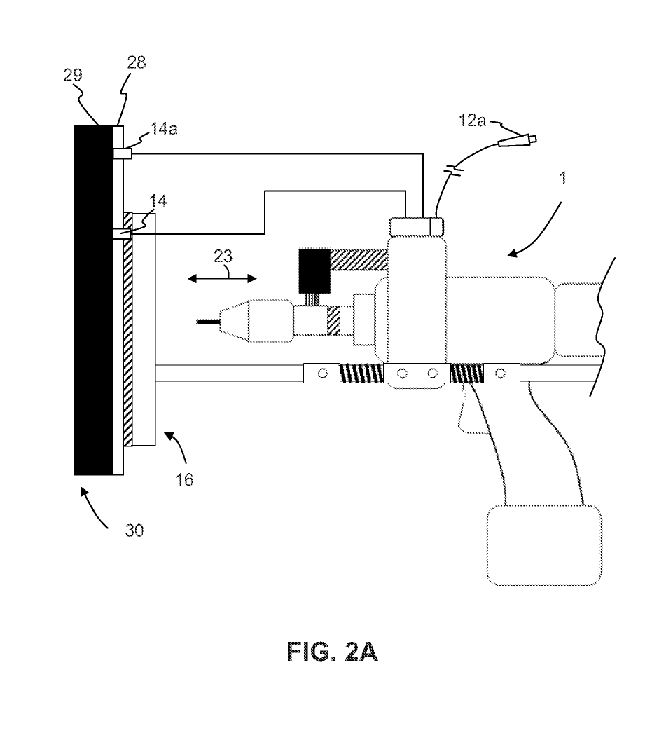

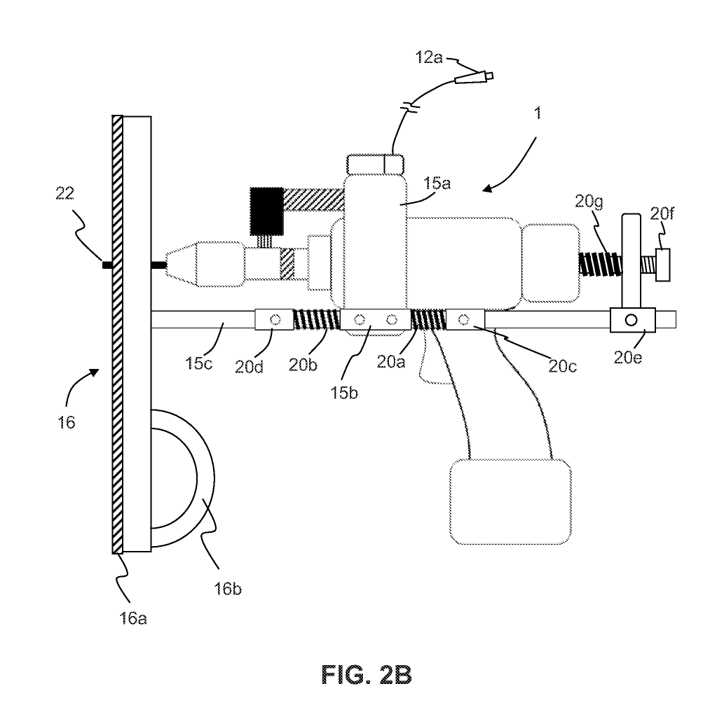

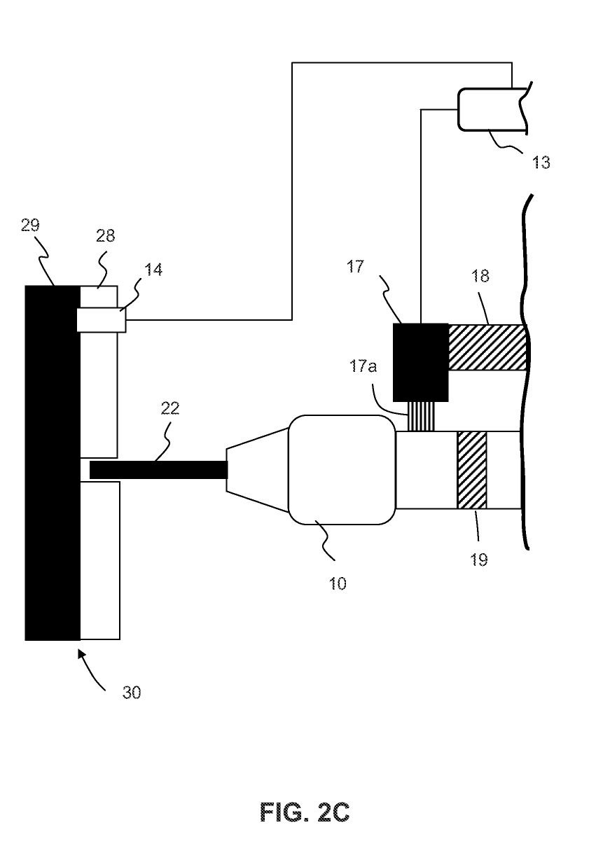

The tool body (1) can be adjusted along the main frame bar (15c) so that the cutting element (22) can reach beyond the frame base (16) (FIG. 2B) for desired cutting depth. The advancing springs (20g), and optionally the second advancing springs (20a), can be positioned and adjusted so that a suitable advancing force can be produced. The balance springs (20b) can provide a balancing force to keep the tool body in place. The second advancing springs can provide additional control or adjustment.

The advancing controller assembly can be adjusted differently when the rotary tool is cutting at different configurations. For cutting at horizontal configurations, the advancing springs (20g) can provide most of the advancing force. The advancing force can be fine tuned by adjusting the balance springs and the second advancing springs. Fur cutting upwards in which the rotary tool is placed under the coated article in vertical direction and the cutting element is pointing upwards, the advancing springs need to be adjusted to provide adequate advancing force countering the weight of the tool body. For cutting downwards in which the rotary tool is placed above the coated article in vertical direction and the cutting element is pointing downward, the advancing springs need to be adjusted to provide adequate upwards force to counter the downward weight of the tool body. The balancing springs can also be used to counter the downward weight of the tool body and to adjust advancing force. A net advancing force is the net outcome force from the weight of the tool body, the advancing springs, the balancing springs, the second advancing springs, and frictions between the frame bars and sliding parts involved. The net advancing force can be measured. In one example, a net upwards advancing force can be measured by pushing a cutting element assembled in the rotary tool or the tool body itself upwards against a force gage. In another example, a net downwards force can be measured by pushing a cutting element assembled in the rotary tool or the tool body itself downwards against a force gage. In yet another example, a net horizontal force can be measured by pushing a cutting element assembled in the rotary tool or the tool body itself horizontally against a force gage.

The portable rotary tool can further comprise a second reference terminal (14a) connected to the motive controller for examining whether the electrical reference terminal (14) is in good electrical contact with the conductive substrate.

The frame base can have an opening to allow the cutting element passing through reaching the coated article. The frame base (16) can comprise one or more additional layers (16a) selected from an adhesion layer, a magnetic layer, a pad layer, or a combination thereof. The adhesion layer and the magnetic layer can help to position the rotary tool over the coated article. The pad layer can provide protection over the coating layer to reduce surface damage such as scratch. The frame base can further comprise one or more additional handles (16b).

The cutting element can have a cutting dimension in a range of from 5 micrometers to 10 millimeters. The term “cutting dimension” of a cutting element refers to the largest cross-sectional dimension of the cutting area of a cutting element. The cross-sectional dimension can be measured perpendicular to the rotational axis of the cutting element. One or more types of cutting elements can be suitable. A combination of cutting elements having different cutting dimensions and types can also be used. In one example, the cutting element can be a drill bit. The drill bit can have one or more straight or helical flutes. The drill bit can have 2, 3 or 4 flutes. The drill can have a flat cutting edge or an angled cutting edge. In another example, the cutting element can be an abrasion tip. The abrasion tip can comprise an abrasion surface having abrasive materials. The abrasive material can be selected from: metal oxide, such as aluminum oxide or chromium oxide; silicon or derivatives, such as silicon carbide; metal alloys, such as alumina-zirconia (an aluminum oxide-zirconium oxide alloy); ceramics; ceramic metal oxide, such as ceramic aluminum oxide; diamond; or a combination thereof.

The cutting element can have different hardness. The cutting element can have the hardness less than, equal to, or higher than the hardness of the conductive substrate. Typical conventional cutting elements, such as drill bits made from steel, high carbon steel, carbides, diamond, or metal oxide can be suitable. A cutting element having the hardness less than the hardness of the conductive substrate can be used to produce a cut with just the coating layers removed without cutting into the conductive substrate. A cutting element having the hardness higher than the hardness of the conductive substrate can be used to cut into the conductive substrate.

This disclosure is also directed to a portable rotary tool kit. The portable rotary tool kit can be used to assemble the aforementioned portable rotary tool. The portable rotary tool kit can comprise:

a) a rotatable member (10) adapted to receive a cutting element, the rotatable member being electrically conductive;

b) a motive source (11) attachable to said rotatable member for rotating said rotatable member;

c) an insulator coupling for coupling said motive source and said rotatable member so that when assembled, said motive source being electrically insulated from said rotatable member;

d) a motive controller (12) for controlling power supply and rotation directions of the motive source; and

e) a sensing device (13) for coupling to said motive controller (12), said sensing device being electrically connectable to the rotatable member (10) and an electrical reference terminal (14); and

f) an advancing controller assembly for advancing said rotatable member along a rotational axis of said rotatable member.

The portable rotary tool kit can further comprise:

g) a main frame (15) attachable to said motive source; and

h) a frame base (16) attachable to said main frame.

The portable rotary tool kit can further comprise a battery pack (21), a handle (50) attachable to the tool body and additional handles (16b) attachable to the frame base (16),

The portable rotary tool kit can further comprise one or more cutting elements having a cutting dimension in a range of from 5 micrometers to 10 millimeters. Any of the aforementioned cutting elements can be suitable.

Any of aforementioned predetermined forward rotation rates, reverse rotation rates, predetermined reverse time period or predetermined number of reverse rotations can be suitable.

The portable rotary tool kit can be packaged in one or more packages and can be assembled by a user.

This disclosure is further directed to a process for producing one or more assay areas on a coated article (FIGS. 2A and 2B). The coated article (30) can comprise a conductive substrate (29) and one or more non-conductive coating layers (28) coated over the conductive substrate. The process can comprise the steps of:

(A) providing a portable rotary tool comprising:
a) a rotatable member (10) adapted to receive a cutting element, the rotatable member being electrically conductive;
b) a motive source (11) for rotating the rotatable member, said motive source and said rotatable member being electrically insulated from each other;
c) a motive controller (12) for controlling power supply and rotation directions of the motive source;
d) a sensing device (13) functionally coupled to said motive controller (12), said sensing device being electrically connected to the rotatable member (10) and an electrical reference terminal (14);
e) a main frame (15) attached to said motive source and a frame base (16) attached to said main frame, said main frame (15) comprising an adjustable section (20); and
f) an advancing controller assembly for advancing said rotatable member along a rotational axis of said rotatable member;

(B) attaching the cutting element to said rotatable member (10), said cutting element being conductive and in conductive contact with said rotatable member;

(C) positioning said portable rotary tool over the coated article at a first position;

(D) connecting said electrical reference terminal (14) to said conductive substrate so that said electrical reference terminal and said conductive substrate are in conductive contact;

(E) providing a forward signal to said motive controller (12) to power said motive source causing forward rotation of said rotatable member and said attached cutting element at a predetermined forward rotation rate;

(F) advancing said cutting element with said advancing controller assembly to cut through said one or more non-conductive coating layers at said first position; and

(G) interrupting the power supply to the motive source after a predetermined time delay or a predetermined number of rotations when said sensing device detects a flow of electric current through the rotatable member and the electrical reference terminal.

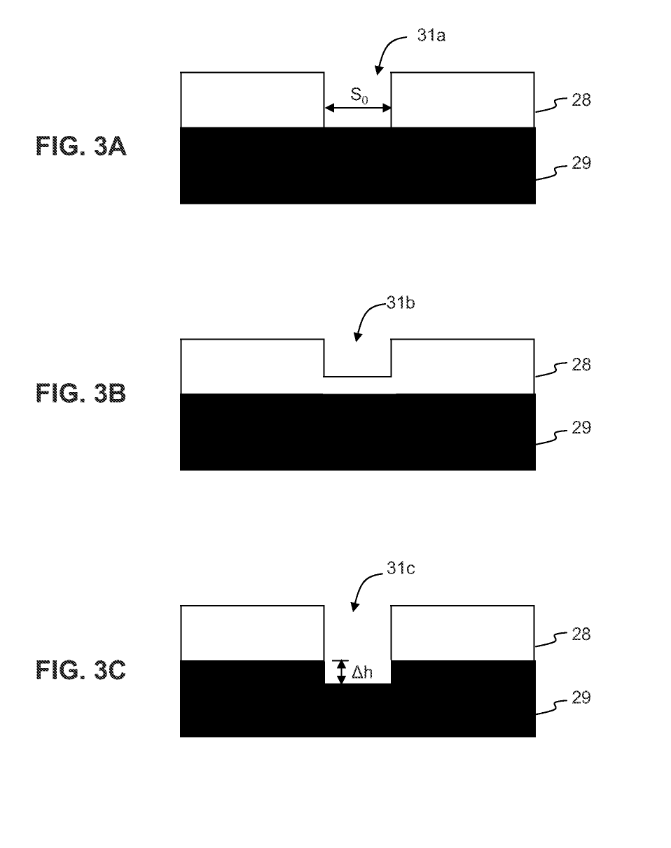

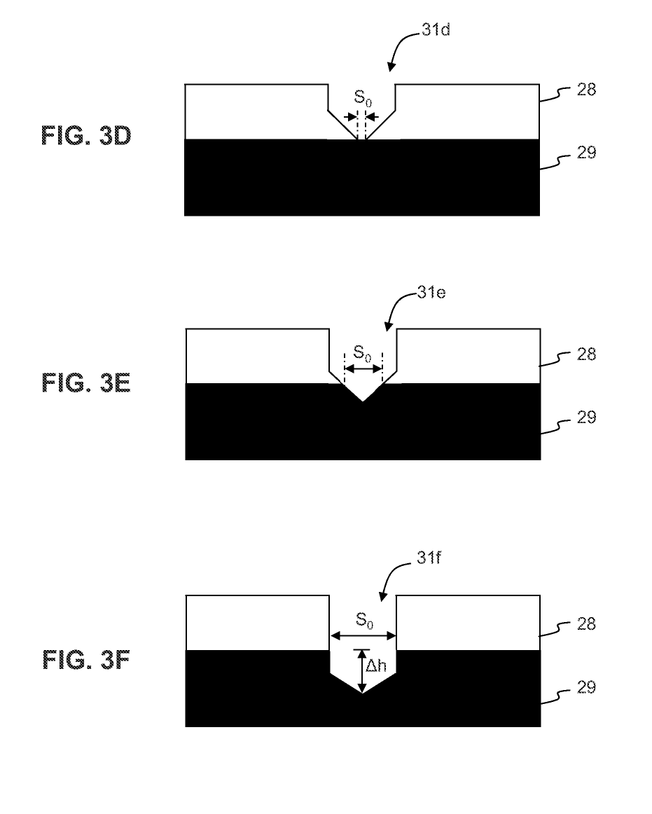

When the cutting element cuts through the coating layers (28) and gets in contact with the conductive substrate (29), an electric current can flow through the rotatable member (10) via the conductive coupler (17) that comprises a constant contact means (17a), the conductive substrate and the electrical reference terminal (14). The sensing device can detect the flow of the current and causing the motive source to interrupt power supply to the motive source (FIG. 2C). The predetermined delay or the predetermined number of rotations can allow the cutting element to continue cutting reaching a desired depth Δh (FIG. 3A-3F). The predetermined delay or the predetermined number of rotations can be determined based on the shape of the cutting element or based on desired depth Δh.

The process can further comprise the steps of:

(H) providing subsequent power supply to said motive source after the step (G) and causing said motive source to rotate at a reverse rotation direction for a predetermined reverse time period or for a predetermined number of reverse rotations.

The process can further comprise the steps of positioning said portable rotary tool over the coated article at a subsequent position and repeating the steps (E) and (H) at said subsequent position. A predetermined pattern template can be used to guide for placing the coated article in the first or the subsequent position. In one example, a paper template can be used to layout the positions of assay areas on a coated substrate in a predetermined pattern. In another example, a ruler can be used to guide the layout of assay areas on a coated substrate. When the coated article can not be moved, such as a bridge or a building, the portable rotary tool can be moved and positioned at a specific position.

Any of the aforementioned predetermined time delay, predetermined number of rotations, predetermined reverse time period or predetermined number of reverse rotations, forward rotation rates, and reverse rotation rates can be suitable.

The process can further comprising the steps of connecting a second reference terminal (14a) connected to said motive controller to said conductive substrate and measuring a flow of electric current through said electrical reference terminal (14) and said second reference terminal (14a) after the step D) prior to the step E). These steps can examine whether the electrical reference terminal (14) is in good electrical contact with the substrate to ensure the motive controller can function properly. The second reference terminal (14a) can be connected and disconnected to the motive controller by a switch.

The coated article can be a coating test panel, a vehicle body, or a vehicle body part. The coating test panel can comprise a metal substrate and one or more organic coating layers. The coating test panel can also be a part of a structure, such as a part of a bridge, a building or a building part; a machinery, such as a machine part; a vehicle, such as a part of a car, a part of a train, a part of an aircraft, or a part of a water vessel; an appliance, such as a part of a household appliance; a sports equipment; or any other articles or article parts having a conductive substrate and one or more coating layers. The portable rotary tool is particularly useful for producing standardized assay areas on large structures, such as bridges, buildings, large vehicles, or other large objects.

The organic coating layers can have a thickness in a range of from 0.001 millimeter (mm) to 10 mm in one example, 0.001 mm to 5 mm in another example, in a range of from 0.001 mm to 2 mm in another example, in a range of from 0.001 mm to 1 mm in yet another example, in a range of from 0.001 mm to 0.5 mm in yet another example, in a range of from 0.001 mm to 0.1 mm in a further example.

The disclosed process, portable rotary tool, portable rotary tool kit or control unit can be used to producing standardized assay areas on organic coatings.

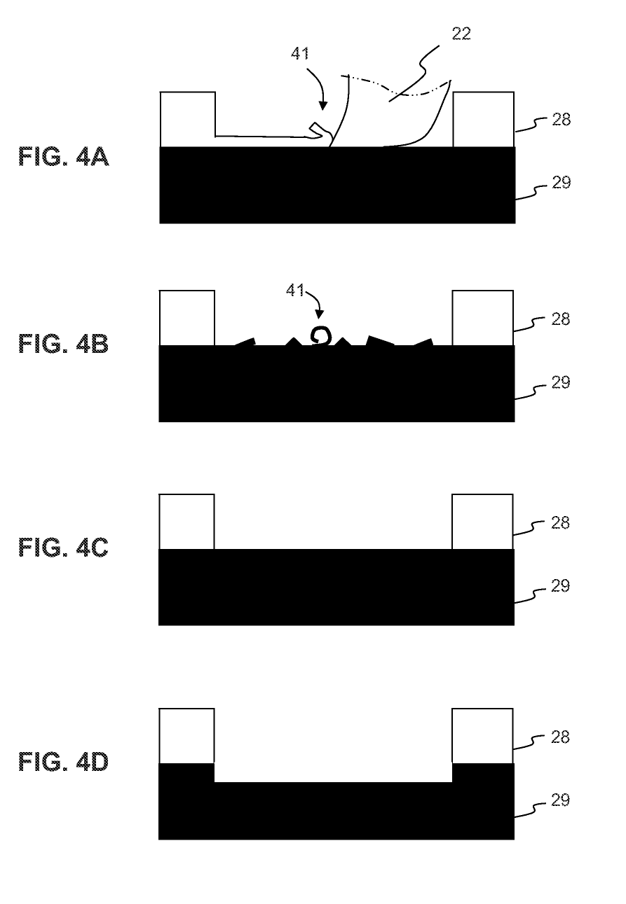

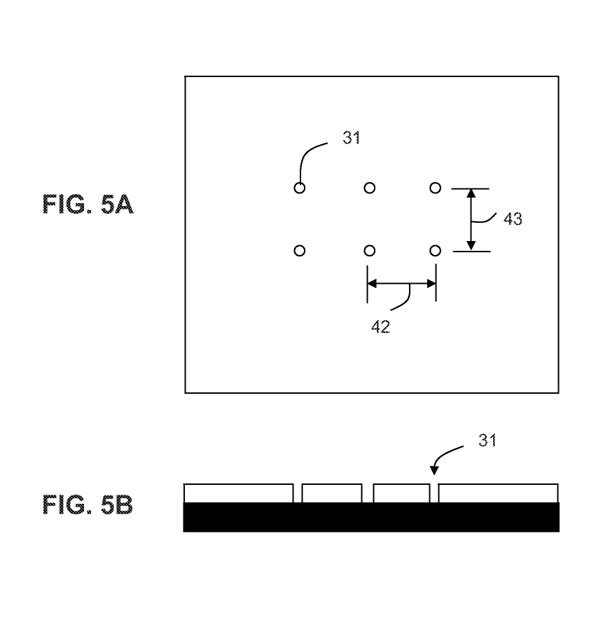

In order to assess properties of the coating layer(s) (28), such as adhesion and corrosion protection, over the conductive substrate (29), one or more small assay areas (31) can be produced (FIGS. 3 and 5). The assay areas can have different variables with different assay surface areas (S₀) of the conductive substrate (31a-31f) (FIG. 3) exposed. The assay surface area (S₀) refers the sum of all surface areas exposed including the side wall areas of the conductive substrate. An under-cut assay area can have some or all of the coating layers still intact (31b, 31d and 31e). An assay area can also have different depth (Δh) cutting into the conductive substrate. When the cutting element stops cutting, it can produce debris or partial cuts (41) (FIGS. 4A and 4B). Such debris or partial cuts can affect size of actual assay area therefore affecting assay results. All these variables can make comparisons of results from a plurality of assays difficult or impossible.

Using the process of this disclosure, the assay areas can be produced with standardized specifications, such as a specified assay surface area (S₀) and a specified depth (Δh) into the conductive substrate. When the cutting element gets into contact with the conductive substrate, a flow of electric current can occur that flows through the rotatable member, the cutting element and the electrical reference terminal that is electrically connected to the conductive substrate. The motive controller can interrupt the power supply to the motive source after a predetermined time delay or a predetermined number of rotations when the sensing device detects the flow of electric current.

The predetermined time delay or the predetermined number of rotations can depend upon the shape of the cutting element, desired depth into the conductive substrate, or a combination thereof and should be sufficient for producing the desired cuts. In one example, a V-shaped cutting drill bit can be used, and a 5 second delay can be predetermined to allow the drill bit to cut into the substrate at its full cutting dimension. In another example, a flat drill bit can be used and 10 additional rotations can be used to allow the drill bit to cut into the substrate. A combination of predetermined time delay and predetermined number of rotations can also be suitable.

According to the process of this disclosure, a reverse rotation can be used. In one example, the reverse rotation can produce an assay area having a smooth surface by removing debris and partial cuts (FIGS. 4C and 4D). In another example, the reverse rotation can help for withdrawing the drill bit.

The process of this disclosure can produce standardized assay areas on the coated substrate in a predetermined pattern. In one example, 6 or more assay areas can be produced in multiple rows and columns. Each of the assay areas can have a predetermined distance away from next assay area (42 and 43) (FIG. 5). Each of the assay area can have a diameter of about 300 μm. Distance between to assay areas (42 and 43) can be in a range of from 5 mm to 20 mm.

What is claimed is:

1. A portable rotary tool comprising:
a) a rotatable member (10) adapted to receive a cutting element, the rotatable member being electrically conductive;
b) a motive source (11) attached to said rotatable member for rotating the rotatable member, said motive source being electrically insulated from said rotatable member;
c) a motive controller (12) for controlling power supply and rotation directions of the motive source;
d) a sensing device (13) functionally coupled to said motive controller (12), said sensing device being electrically connected to the rotatable member (10) and an electrical reference terminal (14);
e) a main frame (15) attached to said motive source and a frame base (16) attached to said main frame; and
f) an advancing controller assembly for advancing said rotatable member along a rotational axis of said rotatable member.

2. The portable rotary tool of claim 1, wherein said motive controller is configured to interrupt the power supply to the motive source after a predetermined time delay or a predetermined number of rotations when said sensing device detects a flow of electric current through the rotatable member and the electrical reference terminal.

3. The portable rotary tool of claim 2, wherein said predetermined time delay is in a range of from 0 second to 60 seconds.

4. The portable rotary tool of claim 2, wherein said predetermined time delay is in a range of from 0.01 second to 5 seconds.

5. The portable rotary tool of claim 2, wherein said motive controller is further configured to subsequently provide power supply to said motive source and to cause said motive source to rotate at a reverse rotation direction for a predetermined reverse time period or for a predetermined number of reverse rotations.

6. The portable rotary tool of claim 1, wherein said motive controller is configured to cause said motive source to rotate the rotatable member at a forward rotation rate in a range of from 1 to 1000 rpm.

7. The portable rotary tool of claim 1, wherein said motive controller is configured to cause said motive source to rotate the rotatable member at a forward rotation rate in a range of from 5 to 20 rpm.

8. The portable rotary tool of claim 1, wherein said motive controller is configured to cause said motive source to rotate the rotatable member at a reverse rotation rate in a range of from 1 to 1000 rpm.

9. The portable rotary tool of claim 1, wherein said cutting element has a cutting dimension in a range of from 5 micrometers to 10 millimeters.

10. The portable rotary tool of claim 1 further comprising a second reference terminal (14a) connected to said motive controller.

11. The portable rotary tool of claim 1, wherein said advancing controller assembly comprises one or more advancing springs (20g) for advancing said motive source, one or more advancing fixers (20e) for attachment between said advancing springs and the main frame, and one or more advancing adjusters (20f) for adjusting said advancing springs, wherein said advancing springs (20g) are positioned in alignment with said rotational axis.

12. A portable rotary tool kit comprising:
a) a rotatable member (10) adapted to receive a cutting element, the rotatable member being electrically conductive;
b) a motive source (11) attachable to said rotatable member for rotating said rotatable member;
c) an insulator coupling for coupling said motive source and said rotatable member so that when assembled, said motive source being electrically insulated from said rotatable member;
d) a motive controller (12) for controlling power supply and rotation directions of the motive source;
e) a sensing device (13) for coupling to said motive controller (12), said sensing device being electrically connectable to the rotatable member (10) and an electrical reference terminal (14); and
f) an advancing controller assembly for advancing said rotatable member along a rotational axis of said rotatable member.

13. The portable rotary tool kit of claim 12 further comprising:
g) a main frame (15) attachable to said motive source; and
h) a frame base (16) attachable to said main frame.

14. The portable rotary tool kit of claim 12 further comprising one or more cutting elements having a cutting dimension in a range of from 5 micrometers to 10 millimeters.

15. The portable rotary tool kit of claim 12 further comprising a second reference terminal (14a) connectable to said motive controller.

16. The portable rotary tool kit of claim 12, wherein said advancing controller assembly comprises one or more advancing springs (20g) for advancing said motive source, one or more advancing fixers (20e) for attachment between said advancing springs and the main frame, and one or more advancing adjusters (20f) for adjusting said advancing springs, wherein said advancing springs (20g) are positioned in alignment with said rotational axis.

17. A process for producing one or more assay areas on a coated article, said coated article comprises a conductive substrate and one or more non-conductive coating layers coated over said conductive substrate, said process comprising the steps of:
(A) providing a portable rotary tool comprising:
a) a rotatable member (10) adapted to receive a cutting element, the rotatable member being electrically conductive;
b) a motive source (11) for rotating the rotatable member, said motive source and said rotatable member being electrically insulated from each other;
c) a motive controller (12) for controlling power supply and rotation directions of the motive source;
d) a sensing device (13) functionally coupled to said motive controller (12), said sensing device being electrically connected to the rotatable member (10) and an electrical reference terminal (14);
e) a main frame (15) attached to said motive source and a frame base (16) attached to said main frame; and
f) an advancing controller assembly for advancing said rotatable member along a rotational axis of said rotatable member;
(B) attaching the cutting element to said rotatable member (10), said cutting element being conductive and in conductive contact with said rotatable member;
(C) positioning said portable rotary tool over the coated article at a first position;
(D) connecting said electrical reference terminal (14) to said conductive substrate so that said electrical reference terminal and said conductive substrate are in conductive contact;
(E) providing a forward signal to said motive controller (12) to power said motive source causing forward rotation of said rotatable member and said attached cutting element at a predetermined forward rotation rate;
(F) advancing said cutting element with said advancing controller assembly to cut through said one or more non-conductive coating layers at said first position; and
(G) interrupting the power supply to the motive source after a predetermined time delay or a predetermined number of rotations when said sensing device detects a flow of electric current through the rotatable member and the electrical reference terminal.

18. The process of claim 17, wherein said predetermined time delay is in a range of from 0 second to 60 seconds.

19. The process of claim 17, wherein said predetermined time delay is in a range of from 0.01 seconds to 5 seconds.

20. The process of claim 17 further comprising the steps of:
(H) providing subsequent power supply to said motive source after the step (G) and causing said motive source to rotate at a reverse rotation direction for a predetermined reverse time period or for a predetermined number of reverse rotations.

21. The process of claim 20 further comprising the steps of positioning said portable rotary tool over the coated article at a subsequent position and repeating the steps (E) and (H) at said subsequent position.

22. The process of claim 20, wherein said reverse rotation rate is in a range of from 1 to 1000 rpm.

23. The process of claim 20, wherein said reverse rotation rate is in a range of from 5 to 20 rpm.

24. The process of claim 17, wherein said predetermined forward rotation rate is in a range of from 1 to 1000 rpm.

25. The process of claim 17, wherein said forward rotation rate is in a range of from 5 to 20 rpm.

26. The process of claim 17 further comprising the steps of connecting a second reference terminal (14a) connected to said motive controller to said conductive substrate and measuring a flow of electric current through said electrical reference terminal (14) and said second reference terminal (14a) after the step D) prior to the step E).
